(19) United States
(12) Patent Application Publication
(10) Pub. No.: US 2025/0353201 A1
(43) Pub. Date: Nov. 20, 2025

(54) A System for Adjusting Positions of Rollers in An Outsert Making Machinery

(71) Applicants: Sanjay Madhav DANDEKAR, Pune (IN); Datta Hari DESHPANDE, Pune (IN)

(72) Inventors: Sanjay Madhav DANDEKAR, Pune (IN); Datta Hari DESHPANDE, Pune (IN); Siddharth Dagadu GAVALI, Bhor (IN); Sachin Arjun KHYALE, Pune (IN)

(21) Appl. No.: 18/868,740

(22) PCT Filed: May 17, 2023
(86) PCT No.: PCT/IB2023/055063

§ 371 Date: Nov. 23, 2024

(30) Foreign Application Priority Data
May 25, 2022 (IN) 202221030076

(51) Int. Cl. B26D 3/06; B26D 5/00

(52) U.S. Cl. CPC B26D 3/06; B26D 5/005

(57) ABSTRACT

The present invention relates to a system (100) for adjusting positions of rollers in an outsert making machinery. There are frequent manual errors in existing outsert-making machinery during adjustment of grooving rollers. The system (100) includes an input interface (30) which receives input data regarding geometrical parameters of a strip (13′) and final outsert (16′) which sends data to a processor (50) configured in a workstation (40). The processor calculates an output data in the form of geometrical details of the grooving rollers (21) and positions of the grooving rollers (21) on grooving shaft(s) (22) and displays the output data on a display (60). Based on data displayed, an operator can manually adjust the positions of the grooving rollers (21) or the workstation (40) actuates a mechanism (70) to adjust grooving rollers (21) and a control unit (80) to adjust operational parameters of folding units (14a′, 14b′).

### FIELD OF THE INVENTION

The present invention relates to outsert making machinery. More specifically, the present invention relates to a system for adjusting positions of rollers in an outsert making machinery.

### BACKGROUND OF THE INVENTION

Generally, an outsert making machinery (or a paper folding machine) is used to perform the paper folding operation to create inserts or outserts widely used in pharmaceutical or manufacturing industries. Referring to FIG. 1, a schematic diagram of an existing outsert making machinery (200) is illustrated. The outsert making machinery (200) includes a strip making unit (10′) which includes set of rollers (11′) for folding a paper (12′). The strip making unit (10′) is adapted to make a strip (13′) from the paper (12′). Further, the strip (13′) from the strip making unit (10′) is passed through one or more folding units (14a′, 14b′) which are positioned at predefined locations according for making a predefined folding pattern of an outsert (folded articles). The folding units (14′) include one or more folding rollers (15a′, 15b′) (or one or more folding knives) which are configured to perform cross folds on the strip (13′) to make a final outsert (16′). Details of the strip making unit (10′) and the folding units (14′) are described in a patent document U.S. Pat. No. 4,817,931A.

Referring to FIG. 2, the outsert making machinery (200) includes a grooving assembly (20′) which is positioned between the strip making unit (10′) and the folding units (14′). The grooving assembly (20′) used in the present outsert making machinery (200) is described in a patent document U.S. Pat. No. 1,863,709A. The grooving assembly (20′) includes one or more grooving rollers (21′) slidably mounted on one or more grooving shafts (22′) and the grooving assembly (20′) is arranged with the strip making unit (10′) for receiving strips (13′) from the strip making unit (10′) (as shown in FIG. 3). The positions of the grooving rollers (21′) is adjustable along the grooving shafts (22′) according to the predefined position of grooves (23′) on the strip (13′). The grooving rollers (21′) impart grooves (23′) (or crease) on the strip (13′) at predefined locations to enable easy and accurate folding of the strip (13′) by the folding units (14′).

However, adjusting the locations of grooving rollers (21′) is performed manually, which leads to less accuracy due to manual error and also the process is time consuming. Hence, there is a need for skilled operators to calibrate the grooving rollers (21′). Also, presently the grooving assembly (21′) is functionally combined with the strip making unit (10′) and folding units (14′), due to which during adjustment of the grooving rollers (21′), the folding units (14′) remain idle i.e. folding units (14′) cannot perform folding operations independent from the strip making unit (10′), which leads to increase in operation time. Also, during the adjusting operation of grooving rollers (21′), the user or operator have to access the grooving rollers (21′) inside the machine (200) or has to draw the assembly (21′) out of the machine (200) to change locations of the grooving rollers (21′), which is a time consuming and tedious task.

Therefore, there is a need for a system for adjusting positions of rollers in an outsert making machinery, which overcomes the above-mentioned problems of the prior art.

### OBJECTS OF THE INVENTION

An object of the present invention is to provide a system adjusting positions of rollers in an outsert making machinery.

Another object of the present invention is to provide a system adjusting positions of rollers in an outsert making machinery, which reduces position adjustment errors due to manual adjustment of grooving rollers in a grooving assembly of the outsert making machinery.

Yet another object of the present invention is to provide a system adjusting positions of rollers in an outsert making machinery, which enables the operation of the strip making unit and the folding units independent from each other to reduce the setup time and operation time of the folding units.

### SUMMARY OF THE INVENTION

The present invention relates to a system for adjusting positions of grooving/gripping rollers in an outsert making machinery. The machinery includes a strip making unit. The strip making unit is adapted to make a strip from a paper using a first set of rollers. Further, one or more folding units are adapted to cross fold the strip by one or more folding rollers (or folding knives).

Further, the system includes a grooving assembly. The grooving assembly has one or more grooving rollers therein. The grooving rollers are positioned between the strip making unit and the folding units. The grooving assembly is mounted to the strip making unit to receive the strip therefrom. The grooving rollers are operated to make grooves on the strip.

Further, the system includes an input interface for receiving input data such as length and thickness of the strip, number of cross folds to be made on the strip and geometrical specifications of an outsert. Further, the system includes a work station connected to the input interface. The work station includes a processor which calculates output data in the form of geometrical details of the grooving rollers (or gripping rollers), the position of the grooving rollers from the first reference, a combination of grooving rollers on the grooving shaft and a combinations of the sequence of grooving rollers on the grooving shaft(s) required for enabling the grooving rollers to make grooves on the strip according the input data provided through the input interface and also deriving operational parameters of the folding units for enabling the folding units to fold on the grooves.

Further, the system includes a display connected to the processor which displays the output data calculated by the processor and wherein the grooving rollers (or gripping rollers) are adjusted manually according to the output data from the display or by operating a first position adjusting mechanism of the system and the operational parameters of the folding unit are adjusted manually or by a control unit connected to the folding unit.

In an embodiment, the input interface is a scanner adapted to scan markings of on the strip. In another embodiment, the input interface is a keyboard and the processor is embedded with a computer aided user interface application for receiving details of folds to be made on the strip by the machinery and the geometric details of the grooving/gripping rollers.

In an embodiment, the grooving/gripping rollers are movable on a grooving shaft in the grooving assembly. Both ends of the grooving shaft are connected to a first frame and a second frame. The first frame or the second frame is the first reference. The grooving/gripping rollers are movable between the ends of the grooving shaft sliding thereon and can be fixed at a position between the ends of the grooving shaft by a fastener. The input interface is a camera. The camera is adapted to capture the positions of the grooving/gripping rollers positioned on the grooving shaft.

In an embodiment, the grooving/gripping rollers are movable on a grooving shaft in the grooving assembly. Both ends of the grooving shaft are connected to a first frame and a second frame. The first frame or the second frame is the first reference. The grooving/gripping rollers are movable between the ends of the grooving shaft sliding thereon and can be fixed at a position between the ends of the grooving shaft by a fastener. The first position adjusting mechanism includes a first prime mover connected to the workstation, one or more second prime movers connected to the first prime mover and one or more first moving jaws connected to the second prime movers. The workstation actuates the first prime mover to move the second prime movers linearly along the grooving shaft and further actuates the second prime movers to actuate the first moving jaws to grip the grooving/gripping rollers and place the grooving/gripping rollers on definite positions according to the derived positions of the grooving/gripping rollers from the first reference.

In an embodiment, the system includes a guiding unit. The guiding unit includes one or more visible light torches. The guiding unit is connected to the workstation. The workstation positions the light torches with beams focus accordingly to the derived positions of the grooving/gripping rollers from the first reference. Based on the positions of light torches, an operator can adjust positions of the grooving/gripping rollers from the references with the respective beams positioned thereon.

### BRIEF DESCRIPTION OF THE DRAWINGS

The advantages and features of the present invention will be understood better with reference to the following detailed description of some embodiments of the and claims taken in conjunction with the accompanying drawings, wherein like elements are identified with like symbols, and in which;

FIG. 1 shows a schematic diagram of an existing outsert making machinery;

FIG. 2 shows a schematic diagram of a grooving assembly of the existing outsert making machinery shown in FIG. 1;

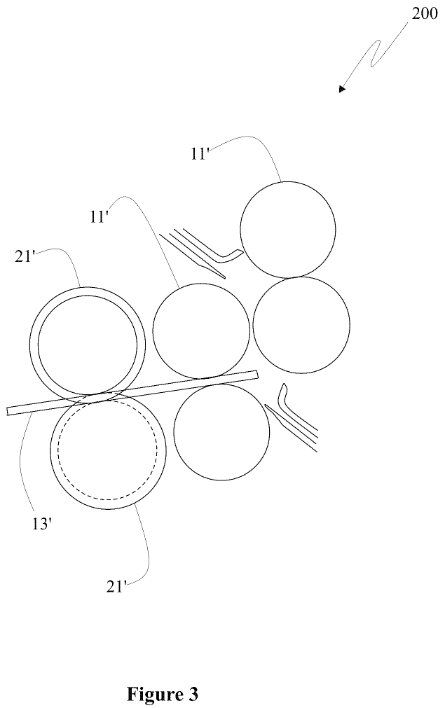

FIG. 3 shows a schematic side view of folding rollers and grooving rollers in the existing outsert making machinery shown in FIG. 1;

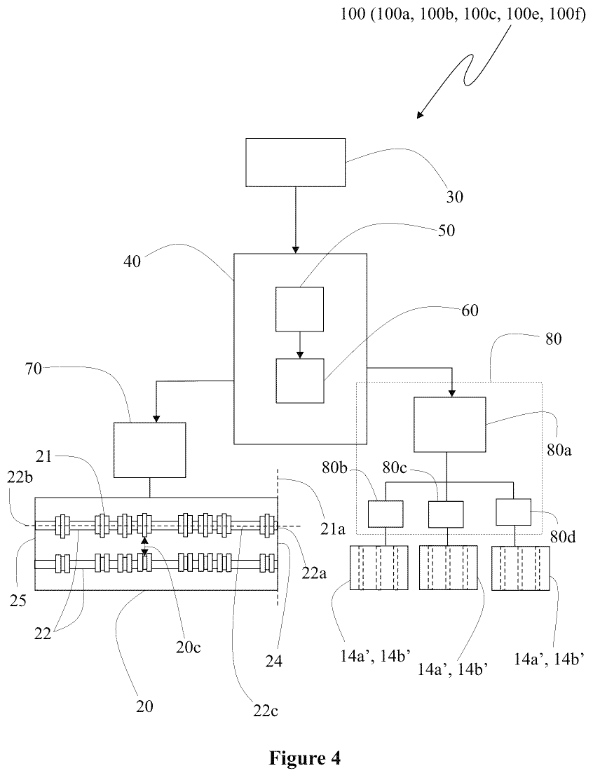

FIG. 4 shows a schematic diagram of a system for adjusting positions of grooving/gripping rollers in an outsert making machinery in accordance with the present invention;

FIGS. 4a, 4b and 4c show schematic diagrams of an output data provided by a display in the system, as shown in FIG. 4;

FIG. 5 shows a schematic diagram of an alternative embodiment of a system for adjusting positions of grooving rollers in an outsert making machinery in accordance with the present invention;

FIG. 6 shows a schematic diagram of one more alternative embodiment a system for adjusting positions of grooving rollers in an outsert making machinery in accordance with the present invention;

FIG. 7 shows a schematic diagram one more alternative embodiment a system for adjusting positions of grooving rollers in an outsert making machinery in accordance with the present invention;

FIG. 8 shows a schematic diagram of one more alternative embodiment a system for adjusting positions of grooving rollers in an outsert making machinery in accordance with the present invention;

FIGS. 9a and 9b show schematic diagrams of an input data provided through the input interface and an output data displayed on the display in the system as shown in FIG. 4;

FIG. 10 shows a schematic diagram of one more alternative embodiment a system for adjusting positions of grooving rollers in an outsert making machinery in accordance with the present invention;

FIG. 11 shows a perspective view of an existing outsert making machinery;

FIGS. 12 and 14 show isometric views of a grooving roller adjusting apparatus in accordance with the present invention;

FIG. 14 shows an isometric view of an embodiment of a grooving roller adjusting apparatus in accordance with the present invention;

FIG. 15 shows an isometric view of one more embodiment of a grooving roller adjusting apparatus in accordance with the present invention;

FIG. 16 shows a side view of one more embodiment of a grooving roller adjusting apparatus in accordance with the present invention; and

FIG. 17 shows a top view of one more embodiment of a system for adjusting positions of grooving rollers in an outsert making machinery in accordance with the present invention.

### DETAILED DESCRIPTION OF THE INVENTION

An embodiment of this invention, illustrating its features, will now be described in detail. The words “comprising, “having, “containing,” and “including,” and other forms thereof, are intended to be equivalent in meaning and be open-ended in that an item or items following any one of these words is not meant to be an exhaustive listing of such item or items or meant to be limited to only the listed item or items.

The terms “first,” “second,” and the like, herein do not denote any order, quantity, or importance, but rather are used to distinguish one element from another, and the terms “an” and “a” herein do not denote a limitation of quantity, but rather denote the presence of at least one of the referenced items.

The disclosed embodiments are merely exemplary of the invention, which may be embodied in various forms.

The present invention relates to a system for adjusting positions of grooving rollers in an outsert making machinery. The system reduces position adjustment errors due to manual adjustment of grooving rollers in a grooving assembly. Also, the system enables the operation of the strip making unit and the folding units independent from each other to reduce the idle time of the folding units during setting of the machinery.

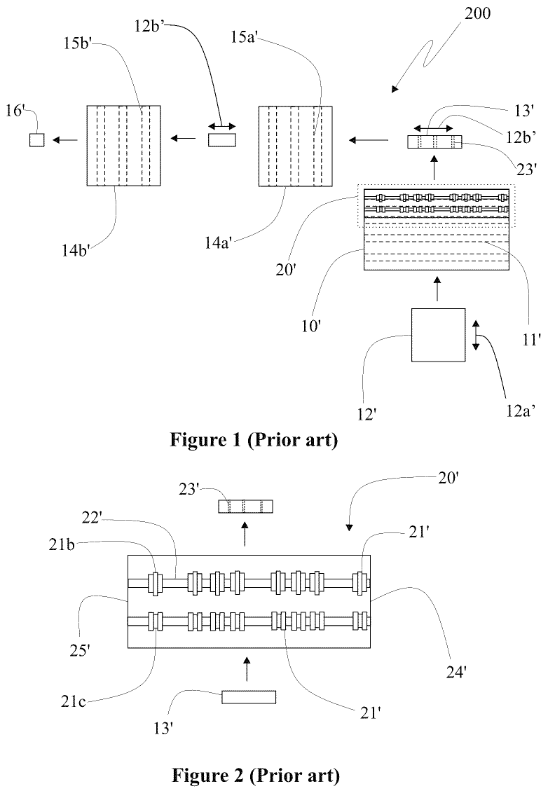

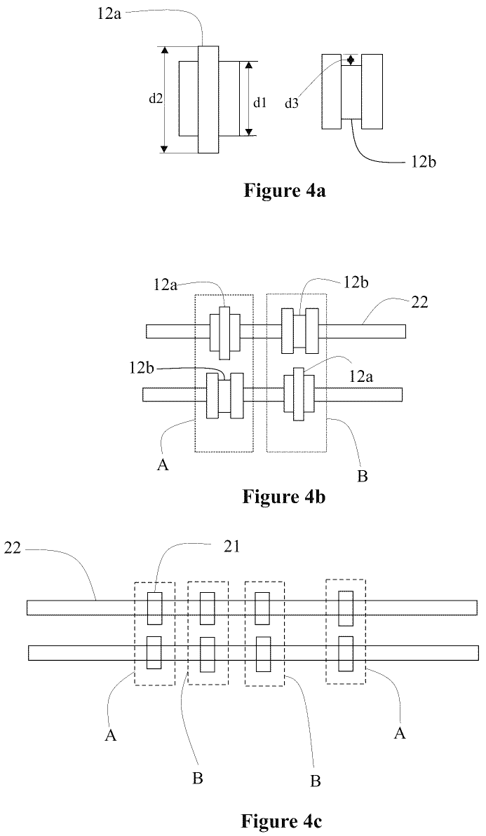

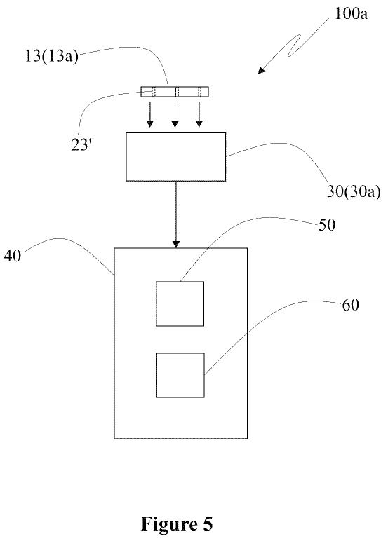

Referring to FIG. 4, a schematic diagram of a system (100, 100a, 100b, 100c, 100e, 100f) for adjusting positions of grooving rollers (21) in an outsert making machinery (200) in accordance with the present invention is illustrated. The outsert making machinery (200) performs multiple folding operations on a paper (12′) to form a compact final outsert (16′). The machinery (200) includes a strip making unit (10′). The strip making unit (10′) is adapted perform multiple parallel folds on the paper (12′) in a first direction (12a′) to make a strip (13″) from the paper using a first set of rollers (11′) (as shown in FIG. 1).

Further, one or more folding units (14′) are adapted to cross fold the strip (13″) by one or more folding rollers (15a′, 15b′) (or folding knives). The cross fold here refers to folding of the strip (13″) (or intermediate items) in a second direction (12b′) (as shown in FIG. 1). Here, the first direction (12b′) is parallel to the length of the paper (12′) and the second direction (12b′) is in parallel direction to the length of the strip (13″). The first direction (12a′) is perpendicular to the second direction (12b′). In case of a roller folding machine, the folding units (14a′, 14b′) include folding rollers (15a′, 15b′) arranged at definite orientation to perform buckle folding on the strip (13″), whereas in a knife roller folding machine, rollers along with one or more knives (15a′, 15b′) are configured to perform folding on the strip (13″).

Further, the system (100) includes a grooving assembly (20) (as shown in FIG. 4). The grooving assembly (20) has one or more grooving rollers (21) therein. The grooving rollers (21) are positioned between the strip making unit (10′) and the folding units (14a′, 14b′). The grooving assembly (20) is mounted to the strip making unit (10′) for receiving the strip (13″) therefrom. In combination with grooving rollers (21), the gripping rollers are also configured to provide the definite grip and drive movement to the folded strip (13′) while performing the grooving operation. The grooving rollers (21) are operated to make grooves (23′) on the strip (13″).

In the grooving assembly (20) (as shown in FIG. 4), the grooving rollers (21) are movable on a grooving shaft (22). In the present embodiment, two grooving shafts (22) are positioned with a parallel distance therebetween. The grooving shaft (22) is a cylindrical shaft on which the grooving rollers (21) are slidably mounted with mechanisms/fasteners (not shown) to lock the position of the grooving rollers (21) laterally and rotatably on the grooving shaft (22). On one of the grooving shafts (22), few of the grooving rollers (21) mounted on the grooving shaft (22) have a male projection (12a) extending along circumference of the grooving rollers (21) and on opposite grooving shaft (22), few of the grooving rollers (21) have a female recession (12b) extending along circumference of the grooving rollers (21) as shown in FIG. 4 and vice versa.

Further, both ends (22a and 22b) of the grooving shaft (22) are rotatably mounted and connected to a first frame (24) and a second frame (25) as shown in FIG. 4. The first frame (24) or the second frame (25) is a first reference (21a). The first reference (21a) is a vertical reference plane from which distances of the grooving rollers (21) are measured with respect to the present invention in the direction of an axis (22c) of the grooving shaft (22). The first reference (21a) can be taken coplanar with the first frame (24) or with the second frame (25) or at a parallel distance from either the first frame (24) or with the second frame (25), which is as per the convenience of an operator or a user.

The grooving rollers (21) are movable between the ends (22a and 22b) of the grooving shaft (22) sliding thereon and can be fixed at a position between the ends (22a and 22b) of the grooving shaft (21) by a fastener. Every grooving roller (21) has a threaded slot (not shown in figure) therein which is fitted with the fastener to lock the grooving roller (21) on the grooving shaft (21). The grooving rollers (21) are arranged in pairs on the grooving shafts (22) with a definite distance (20c) between the opposite grooving rollers (21) which is approximately equal to the thickness of strip (13′). The definite distance (20c) can be caried to impart variable depth of the groove(s) of the strip (13′).

The grooving rollers (21) are adapted to make grooves (23) on the strip (13′). The grooving rollers (21) perform rotational motion with one roller (21) performs rotation in direction opposite to another roller (21) in the pair. The strip (13′) is passed through the distance between the pair of grooving rollers (21) and the strip (13′) is sandwiched between the rotating grooving rollers (21) and the male projections (12a) and female recessions (12b) on the on the grooving rollers (21) make grooves (23) on the strip (13′). The grooves (23) are depressions made on the strip (13′) along width direction of the strip (13′) at definite width of grooves, locations and orientations according to the predefined folding pattern. The grooves (23) enable easy folding of the strip (13′) along the grooved locations.

Further, the system (100) includes an input interface (30) which is adapted to take input data such as length and thickness of the strip (13′), geometrical specifications (such as length and thickness) of the final outsert (16′) and number of cross folds to be made on the strip (13′)

The input interface (30) is further connected to a workstation (40) which receives data provided to the input interface (30). The workstation (40) is a controller or a microprocessor or a microcontroller or a processor or a logic controller or a computer. Further, the workstation (40) includes a processor (50). The processor (50) processes the details received from the input interface (30) and calculates output data in the form of geometrical details of the grooving rollers (21) (or gripping rollers), the position of the grooving rollers (21) from the first reference (21a), a combination of grooving rollers (21) on the grooving shaft (22) and a sequence of combinations of grooving rollers (21) on the grooving shaft(s) (22).

The geometrical details of the grooving rollers (21) include the diameter (d1) of grooving rollers (21) and magnitude of the length (d2) of the male protrusions (12a) and depth (d3) of female recessions (12b) as shown in FIG. 4a. The combination (A or B) of grooving rollers (21) includes a set of the positions of the grooving rollers (21) on the opposite grooving shaft (22) (as shown in FIG. 4b). (For example—In FIG. 4b, a combination ‘A’ represents position of the grooving roller (21) having the male projection (12a) on upper grooving shaft (22) and position of the grooving roller (21) having the female recession (12b) on the lower grooving shaft (22) opposite to the first grooving roller (21). Similarly, a combination ‘B’ represents position of the grooving roller (21) having the female recession (12b) on upper grooving shaft (22) and position of the grooving roller (21) having the male projection (12a) on the lower grooving shaft (22) opposite to the first grooving roller (21)). Also, a combination C and D include variations in magnitudes of d2 and d3 (i.e. one roller in C is having a definite magnitude of d2 and the roller in D have a definite magnitude of d2 which is different from that of C). The sequence of combinations of grooving rollers (21) refers to the sequence in which the combinations (A or B (or C or D)) of grooving rollers (21) are mounted on the grooving shafts (22) (as shown in FIG. 4c). (For example—AAAA, ABAB, BBBB, ABBA, (as shown in FIG. 4c), ABCD, BCAD etc.).

Also, the processor (50) derives the operational parameters of the folding units (14a, 14b) to enable the folding units (14a, 14b) to fold on the grooves (23). The operational parameters of the folding units (14a, 14b) include the roller (15a, 15b) gap, location and depth of the knife blade and position of the fold stoppers of the folding unit, time and speed of rotation of the folding rollers (or the time and speed of actuation of the folding knives) (15a, 15b), the orientation of stoppers (not shown in figures) within the folding units (14a, 14b) etc. These operational parameters of the folding units (14a, 14b) are dependent on the location of grooving rollers (21). Hence, these parameters must be adjusted before the folding operation on the strip (13′) in the second direction (12b′). The processor (50) is programmed with predefined (preconfigured) mathematical relations (formulas, conditions etc.) for deriving the output data and operational parameters.

Further, a display (60) is connected to the processor (50) for displaying the output data calculated (derived) by the processor (50) such as geometrical details of the grooving rollers (21) (or gripping rollers), the position of the grooving rollers (21) from the first reference (21a), the combination of grooving rollers (21) on the grooving shaft (22) and the sequence of combinations of grooving rollers (21) on the grooving shaft(s) (22).

Based on the output displayed on the display (60), the geometric details, positions, combinations and sequences of the grooving rollers (21) are selected and adjusted manually or adjusted by a first actuating mechanism (70) as shown in FIG. 4. The first actuating mechanism (70) displaces the grooving rollers (21) along the grooving shaft (22) as per the information received from the processor (50).

Also, based on the displayed output parameters on the display (60), the operational parameters of the folding units (14a, 14b) are adjusted manually or by a control unit (80) connected to the folding unit (14a, 14b). In the present embodiment, the control unit (80) is a distributed control unit which includes a primary control unit (80a) which sends signals to one or more secondary control units (80b, 80c, 80d) which are connected to respective folding units (14a, 14b). The primary control unit (80a) receives output from the processor (50), determines the sequence through which the folding units (14a, 14b) have to be activated and accordingly send activation signals to the respective secondary control units (80b, 80c, 80d) which are electrically connected to the actuating units of respective folding units (14a, 14b) such as linear actuators or motors (not shown in figure) and send signals to the actuating units to actuate folding rollers (or folding knives) (15a, 15b) to make cross folds on the strip (13′) and also send readings for manually adjusting the positions on the folding units (14a, 14b).

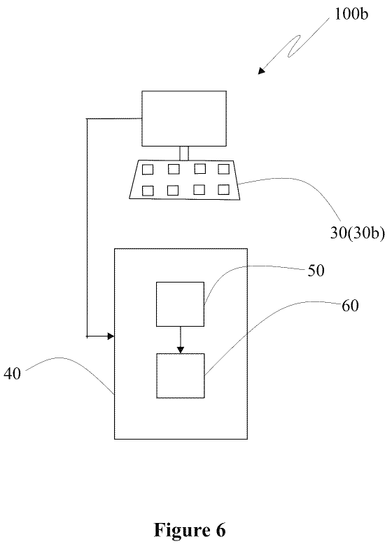

Referring to FIG. 5, an embodiment (100a) of the system (100) for adjusting positions of grooving rollers (21) in an outsert making machinery (200). In the system (100a), the input interface (30a) is a scanner adapted to scan markings of on a strip (13a). The input interface (30a) is any scanning instrument known to the person skilled in the art. Here, the strip (13a) is a standard strip with grooves (23) configured at standard locations. The standard strip can be a hand folded strip by a skilled person. The input interface (30a) records the positions of the grooves (23) on the standard strip (13a), sends the data to the processor (50) which determines output parameters (as explained in para ( ) and displays the output data on the display (60).

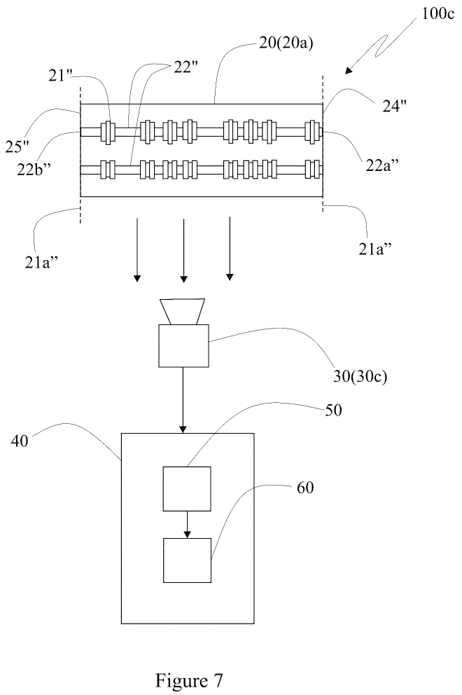

Referring to FIG. 6, an embodiment (100b) of the system (100) for adjusting positions of grooving rollers (21) in an outsert making machinery (200) is illustrated in accordance with the present invention. In the system (100b), the input interface (30b) is a keyboard and the processor is embedded with a computer aided user interface application for receiving details of folds to be made on the strip (13′) by the machinery (200). Here, the input parameters such as length, thickness of the strip (13′), no. of cross folds to be made on the strip (13′), geometrical dimensions of the final outsert (16′) etc. are entered manually into the input interface (30b) and the first actuating mechanism (70) actuates to position the gripping/grooving rollers (21) on the grooving shaft (22) and the control unit (80) sends signals to the actuating units configured within the folding units (14a,14b) to actuate according to conditions entered through the input interface (30b).

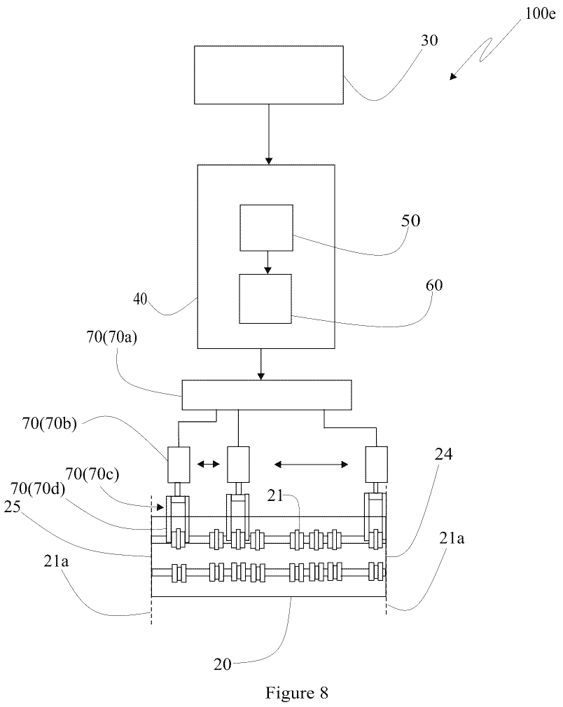

Referring to FIG. 7, an embodiment (100c) of the system (100) for adjusting positions of grooving rollers (21) in an outsert making machinery (200) is illustrated in accordance with the present invention. In the system (100c), the input interface (30c) is a camera. The input interface (30c) (camera) is adapted to capture the positions of the grooving rollers positioned on the grooving shaft (22) of a standard grooving assembly (20a) in a teaching mode. In the grooving assembly (20a), grooving rollers (21″) are movable on a grooving shaft (22″). Both ends (22a″ and 22b″) of the grooving shaft (22″) are connected to a first frame (24″) and a second frame (25″).

The first frame (24″) or the second frame (25″) is a first reference (21a″), the grooving rollers (21″) are movable between the ends (22a″ and 22b″) of the grooving shaft (22″) sliding thereon and can be fixed at a position between the ends (22a″ and 22b″) of the grooving shaft (22″) by a fastener. The camera (input interface (30)) captures images or records videos of the grooving rollers (21″) on the grooving assembly (20a) and sends images or videos to the processor (50). The captured the grooving rollers (21″) will be stored in a memory of the workstation (40) for future use.

When there is a need for adjusting new grooving rollers (21), the system (100c) is operated in an actuation mode. When the system (100c) is in the actuation mode, the processor (50) actuates the first actuating mechanism (70) to adjust the positions of the grooving rollers (21) in the grooving assembly (20) and actuate the control unit (80) to send signals to the actuating units configured within the folding units (14a,14b) to actuate according to conditions entered received through the input interface (30c) (standard data).

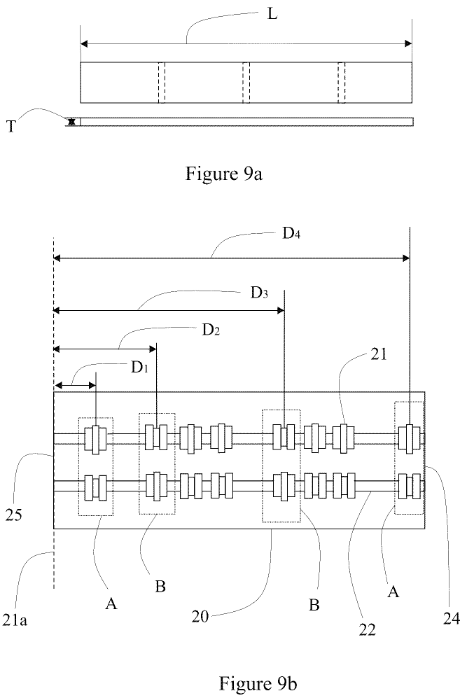

Referring to FIG. 8, an embodiment (100e) of the system (100) for adjusting positions of grooving rollers (21) in an outsert making machinery (200) is illustrated in accordance with the present invention. In the system (100e), the first position adjusting mechanism (70) includes a first prime mover (70a) connected to the workstation. In the present embodiment, the first prime mover (70a) is a hydraulic or pneumatic or electrically operated linear actuator. Further, one or more second prime movers (70) are connected to the first prime mover (70a). In the present embodiment, the second prime movers (70b) are hydraulic or pneumatic or electrically operated linear actuators.

Further, one or more first moving jaws (70c) are connected to each second prime mover (70b) as shown in FIG. 8. The first moving jaws (70c) are robotic arms with two grippers (70d) which are capable of gripping the grooving rollers (21) from both sides and move the rollers (21) from one position to another. The grippers (70d) of the first moving jaws (70a) are driven by second prime movers (70b) connected therewith. The first prime movers (70b) are linear actuators or cam operated actuators connected to a rotary actuator. The first prime movers (70b) are connected to the workstation (40) as shown in FIG. 8. The workstation (40) actuates the first prime movers (70b) to move the grooving rollers (21) by the first moving jaws (70a) according to the derived positions of the grooving rollers (21) from the first reference (21a). Here, the input interface (30) receives information about positions on which the grooving rollers (21) have to be located on the grooving shaft (22) and sends signals to the first actuating mechanism (70) which grips the grooving rollers (21) and moves the grooving rollers (21) to adjust the positions which is required to make accurate grooves (23) on the strip (13′).

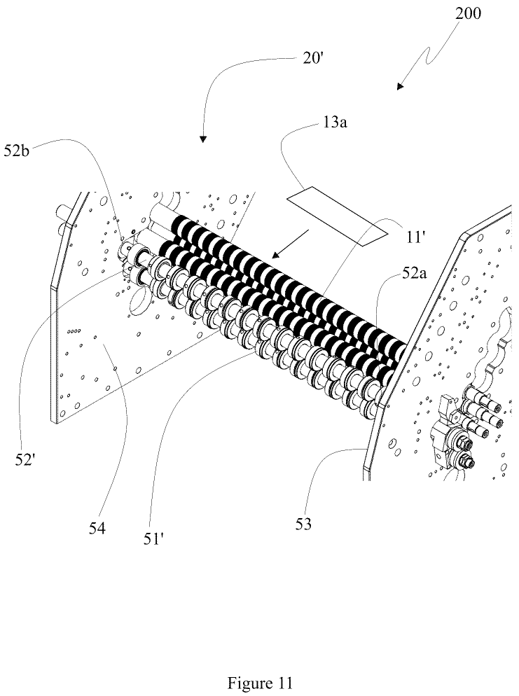

Referring to FIG. 10, an embodiment (100f) of the system (100) for adjusting positions of grooving rollers (21) in an outsert making machinery (200) is illustrated in accordance with the present invention. The system (100f) includes a guiding unit (101). The guiding unit (101) includes one or more visible light torches (102). The guiding unit (101) is a linear actuator (either hydraulic, pneumatic or electrically operated) which moves the light torches (102) in linear direction along the length of the grooving assembly (20). The light torches (102) are luminescent light sources or gas discharge light sources, laser beam or any kind of visible light sources known to the person skilled in the art. The guiding unit (101) is connected to the workstation (40). The workstation (40) receives input from the input interface (30) and actuates the guiding unit (101) to focus the beam on the derived positions of the grooving rollers (21) from the first reference (21a). Based on the positions of light torches (102), an operator can adjust positions of the grooving rollers (21) from the first reference (21a) with the respective light beams positioned thereon. In another embodiment, a camera is mounted on the guiding unit (101) which takes images of the positions of light torches (102) on the grooving shaft (21).

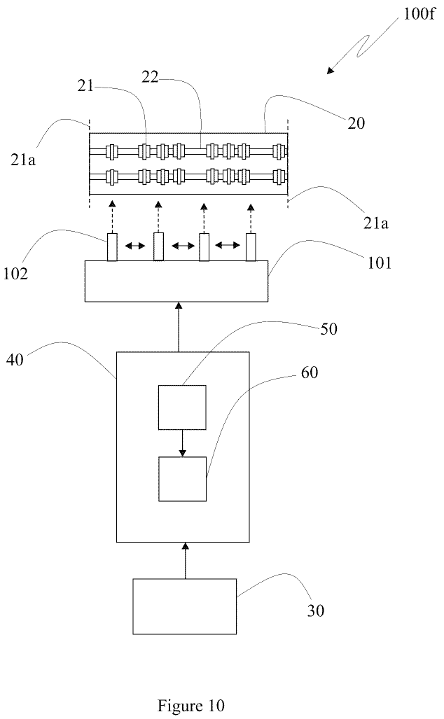

For example—As shown in FIGS. 9a and 9b, let us consider the strip (13′) is having a length L=40 cm (FIG. 9a) and thickness (T)=1 mm. Also, 4 cross folds are to be performed on the strip (13′) and the final outsert (16′) is required to be of length of 3.5 cm The above information is entered into the input interface (30 (30a, 30b, 30c)). The input interface (30) sends the information to the processor (50) in the workstation (40) and the processor calculates the diameter (d1) of the grooving roller (21), the length (d2) of the male projection (12a) and depth (d3) of the female recession (12b), determines the distances (D1, D2, D3 and D4) of the grooving rollers (21) as, determine the combinations A and B and sequences of combination as ABBA (as shown in FIG. 9b). The irrational numbers are removed.

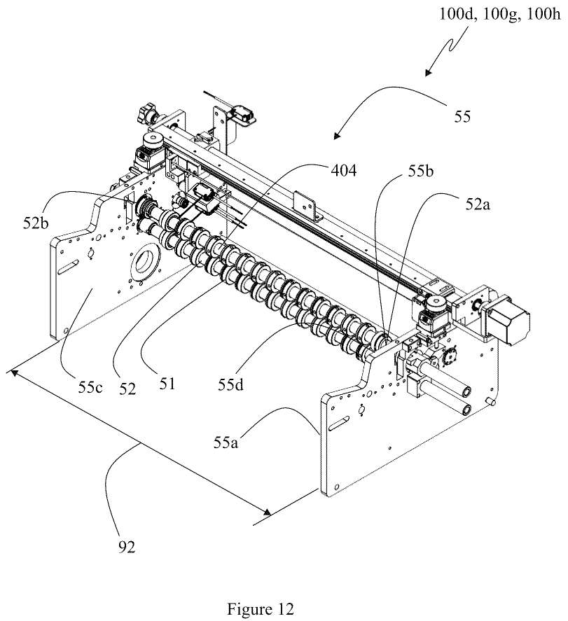

Referring to FIG. 11, 12, 13, 14, 15, 16 or 17, embodiments (100d, 100g, 100h) of system (100) for adjusting positions of rollers in an outsert making machinery (200) in accordance with the present invention are illustrated. The system (100d, 100g, 100h) includes grooving rollers (51) are mounted on a grooving shaft (52). Both ends (52a and 52b) of the grooving shaft (52) are detachably connected to a first side frame (53) and a second side frame (54). The first side frame (53) and the second side frame (54) are connected to the strip making unit (10′). The grooving shaft (52) receives a strip (13a) and performs grooving operation thereon.

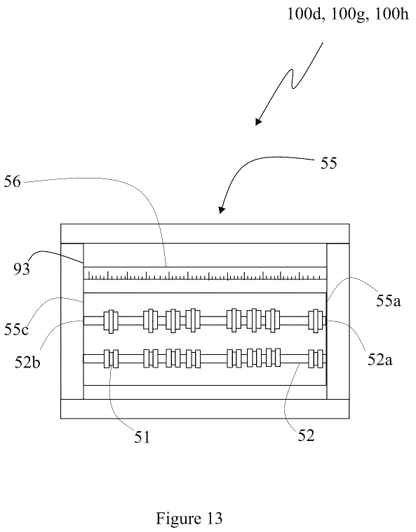

Referring now to FIG. 12, an isometric view of a grooving roller adjusting apparatus (55) in accordance with the present invention is illustrated. The positions of the grooving rollers (51) are adjusted by a grooving roller adjusting apparatus (55) as shown in FIG. 12. The apparatus (55) includes a first apparatus side frame (55a). The first apparatus side frame (55a) has a first fastening mechanism (55b).

Further, the apparatus (55) includes a second apparatus side frame (55b) with a distance (92) from the first apparatus side frame (55a) as shown in FIG. 12. The distance (92) between the first apparatus side frame (55a) and the second apparatus side frame (55b) is equal to the distance between the first side frame (53) and the second side frame (54) (as shown in FIG. 11). The first apparatus side frame (55a) has a second fastening mechanism (55c). The first fastening mechanism (55a) and the second fastening mechanism (55c) are shaft locks. The first fastening mechanism (55a) and the second fastening mechanism (55c) restrict axial movements of the shaft (52) but allows the rotational movements around the shaft (52).

Further, the apparatus (55) includes a scale (56) having marking of distances thereon as shown in FIG. 13. The scale (56) can be a mechanical scale. The scale (56) can be mounted to a frame (93) of the apparatus (55). The direction of markings of the scale (56) is along the axis of the grooving shaft (52). The markings of the scale (56) are visible to an operator. For adjusting positions of the grooving rollers (51) on the grooving shaft (52), the grooving shaft (52) with grooving rollers (51) are detached from the first side frame (53) and the second side frame (54), and the ends (52a and 52b) of the grooving shaft (52) with grooving rollers (51) are connected to the first apparatus side frame (55a) and the second apparatus side frame (55b) though the first fastening mechanism (55b) and the second fastening mechanism (55c).

The first fastening mechanism (55b) and the second fastening mechanism (55c) enables rotational movements of the grooving shaft (52) around the axis of the grooving shaft (52). The grooving rollers (51) are detached from the grooving shaft (52) and moved along the axis of the grooving shaft (52) and the distances of the grooving rollers (51) are adjusted from either from the first side frame (24) or from the second side frame (25) manually or by the first position adjusting mechanism (70) of the system (100d) and the grooving rollers (51) are fixed to the grooving shaft (52) at the adjusted positions. The grooving shaft (52) with the fixed grooving rollers (51) are detached from the first apparatus side frame (55a) and the second apparatus side frame (55b), and fixed to the first frame (24) and the second frame (25).

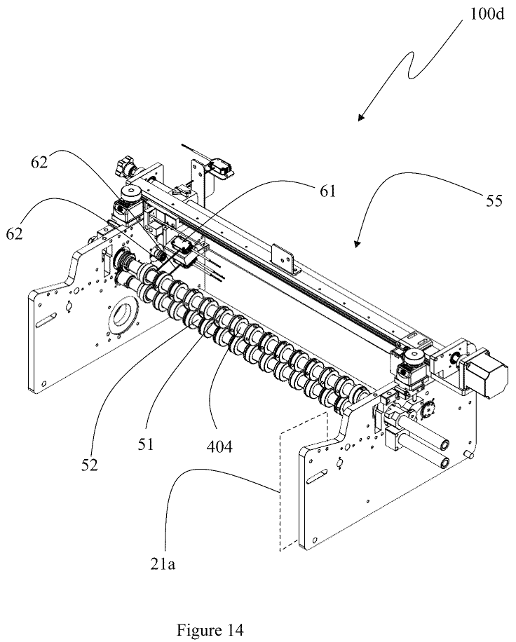

Referring to FIG. 14, an embodiment (100d) of the system (100) for adjusting positions of rollers (gripping rollers/grooving rollers) in an outsert making machinery is illustrated. The system (100d) includes a guiding unit (61). The guiding unit (61) is arranged with the grooving roller adjusting apparatus (55). The guiding unit (61) is similar in structure and function as that of embodiment (100f). The guiding unit (61) includes one or more visible light torches (62). In the present embodiment, the light torches (62) are laser beams. The guiding unit (61) is connected to the workstation (40). The workstation (40) positions the light torches (62) with beams focused on positions according to the derived positions of the grooving rollers (51) from the first reference (21a) as shown in FIG. 13. An operator can adjust positions of the grooving rollers (51) from the first apparatus side frame (55a) and the second apparatus side frame (55b) with the respective beams positioned thereon.

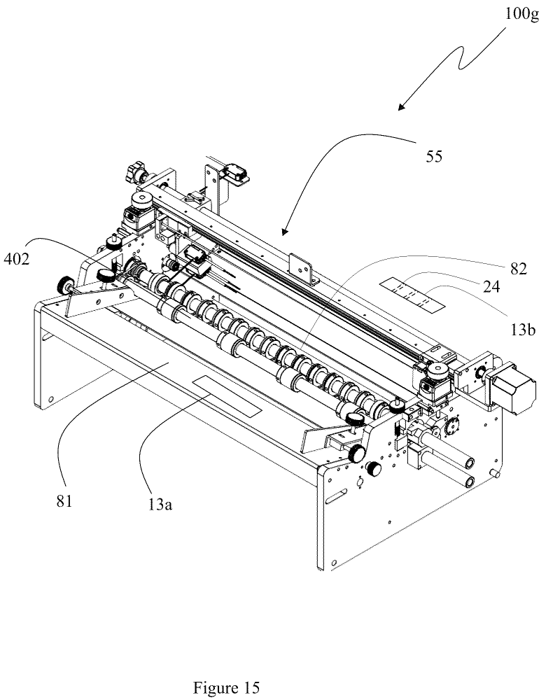

Referring to FIG. 15, an embodiment (100g) of the system (100) for adjusting positions of rollers (gripping rollers/grooving rollers) in an outsert making machinery is illustrated. In the system (100g), the grooving roller adjusting apparatus (55) includes an inlet (81) for receiving a strip (13a) without grooves (24) thereon therethrough. The inlet (81) is a flat conveyor which causes movement of the strip (13a) towards the grooving rollers (51). Upon rotation of the grooving shaft (52) with the fixed grooving rollers (51), the grooving rollers (51) perform grooving operation on the strip (13a) and a strip (13b) with the grooves (24) thereon moves away from the grooving roller adjusting apparatus (55) through an outlet (82) of the apparatus (55). In the system (100g), the apparatus (55) can independently perform grooving operations. Also, the system (100g) enables the user to check the grooving by the grooving rollers without need of complete set of the machinery (200).

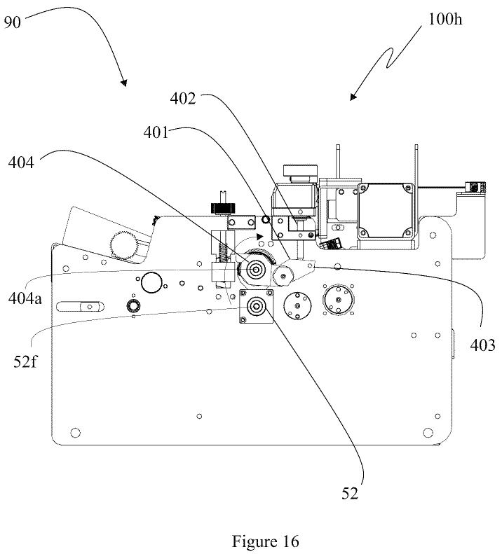

Referring to FIG. 16, an embodiment (100h) of the system (100) for adjusting positions of rollers (gripping rollers/grooving rollers) in an outsert making machinery is illustrated. In the system (100h), one more grooving shafts (52, 404) are fixed to the first apparatus side frame (55a) and the second apparatus side frame (55c). In the present embodiment, two grooving shafts (52 and 404) are arranged with a parallel distance therebetween. The axial distances between two grooving shafts (52 and 404) are adjusted by an axial distance adjusting mechanism (90) as shown in FIG. 16.

The axial distance adjusting mechanism (90) includes a pivotal arm (401) connected to either first/second side frame (53 or 54). One of the two grooving shaft(s) (52) is fixed. End of the pivotal arm (401) is connected to a spring loading element (402). The pivotal arm (401) is having an extension (403). The pivotal arm (401) is connected to the moving second grooving shaft (404). The spring loading elements (402) biases the second movable grooving shaft (404) towards the first grooving shaft (52). Wherein upon applying the force on the extension (403) with more than spring force, the second grooving shaft (404) moves away from the first grooving shaft (52). The direction of movement of the second grooving shaft (404) is shown in FIG. 16. When the second grooving shaft (404) moves away from the first grooving shaft (52), the axes (52f and 404a) of the first grooving shaft (52) and the second grooving shaft (404) are parallel. The pivotal arm (401) keeps the shafts (52, 404) parallel to each other while the second grooving shaft (402) moving away from the first shaft (52).

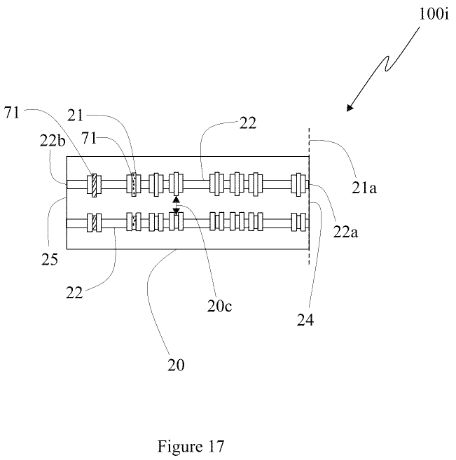

Referring to FIG. 17, an embodiment (100i) of the system (100) for adjusting positions of rollers (gripping rollers/grooving rollers) in an outsert making machinery is illustrated. The system (100i) includes a colour indication (71) on the grooving rollers (21). The colour indications (71) are shown in FIG. 17. Each colour indication (71) shows a different colour such as blue, red, yellow etc. The colour indication is also referred as an “eye mark”. The colour indications (71) (or eye marks) are painted on the male projections (12a) and the female recessions (12b) of the grooving rollers (21) as shown in FIG. 17. The male projections (12a) or female recessions (12b) of a set of grooving rollers (21) are most probably provided with a same colour indication (71), wherein the display (50) displays the combination and sequence of combinations of the grooving rollers (21) with colour indications (71). With this colour indications (71), operator can easily select male projections and female recessions of the grooving rollers (21) for fixing on the grooving shaft (22). Also, when the derived positions of the grooving rollers (22) are displayed on the display (50), a non-literary person (not having knowledge of description language) can adjust the rollers (21) efficiently.

For example, when input data regarding the geometrical details of the strip (13a), no. of cross folds to be made on the strip (13a), final geometrical dimensions of the outsert (16′) is received by the input interface (30), the data is processed by the processor (50) and displays the output data in the form of sequence of colour indications (71) (or eye marks) such as red-red, blue-blue, red-blue etc. Here the first colour indication (71) shows the colour of male projection (12a) or female recession (12b) of the grooving roller (21) on the upper grooving shaft (22) and the second colour indication (71) represents the colour of male projection (12a) or female recession (12b) of the grooving roller (21) on the lower grooving shaft (22). Here, if the display (60) shows combination such as red-red, blue-blue, red-blue, it means that the grooving rollers (21) have to be adjusted on the upper and lower grooving shafts (22) so that grooving rollers (21) of colour indication (71) as red are placed in pair with each other at definite locations.

Thus, the present system (100) provides an advantage of reducing the position adjustment errors due to manual adjustment of grooving rollers (21) on the grooving assembly (20) as well as reduces setup time of entire outsert making machinery (200). Also, the system (100) enables the operation of the strip making unit (10′) and the folding units (14a′, 14b′) independent from each other to reduce the setup time and operation time of the folding units (14a′, 14b′).

The foregoing descriptions of specific embodiments of the present invention have been presented for purposes of illustration and description. They are not intended to be exhaustive or limit the present invention to the precise forms disclosed, and obviously, many modifications and variations are possible in light of the above teaching. The embodiments were chosen and described to explain best the principles of the present invention and its practical application and to thereby enable others skilled in the art to best utilise the present invention and various embodiments with various modifications as are suited to the particular use contemplated. It is understood that various omissions and substitutions of equivalents are contemplated as circumstances may suggest or render expedient, but such omissions and substitutions are intended to cover the application or implementation without departing from the scope of the claims of the present invention.

We claim:

1. A system (100a, 100b, 100c, 100d, 100e, 100f) for adjusting positions of grooving rollers (21) in an outsert making machinery (200), the machinery (200) includes a strip making unit (10′) adapted to make a strip (13′) from a paper (12) using a first set of rollers (11′) therein, one or more folding units (14a′, 14b′) adapted to cross fold the strip (13′) by one or more folding rollers (or folding knives) (15a′, 15b′) therein, a grooving assembly (20) having grooving/gripping rollers (21) positioned between the strip making unit (10a) and the folding units (14a), the grooving assembly (20) is mounted to the strip making unit (10′) for receiving the strip (13′) therefrom, the grooving rollers (21) are operated to make grooves (23′) on the strip (13′), the system (100a, 100b, 100c, 100d, 100e, 100f) characterized in that:
an input interface (30) for receiving input data such as length and thickness of the strip (13′), number of cross folds to be made on the strip (13′) and geometrical specifications of an outsert (16′);
a work station (40) connected to the input interface (30), the work station (40) includes a processor (50) which calculates output data in the form of geometrical details of the grooving rollers (21) (or gripping rollers), the position of the grooving rollers (21) from the first reference (21a), a combination of grooving rollers (21) on the grooving shaft (22) and a sequence of combinations of grooving rollers (21) on the grooving shaft(s) (22) required for enabling the grooving rollers (21) to make grooves (23′) on the strip (13′) according the input data provided through the input interface (30) and also deriving operational parameters of the folding units (14a′, 14b′) for enabling the folding units (14a′, 14b′) to fold on the grooves (23′);
a display (60) connected to the processor (50) which displays the output data calculated by the processor (50); and
wherein the grooving rollers (21) (or gripping rollers) are adjusted manually according to the output data from the display (60) or by operating a first position adjusting mechanism (70) of the system (100); and the operational parameters of the folding unit (14a′, 14b′) are adjusted manually or by a control unit (80) connected to the folding unit (14a′, 14b′).

2. The system (100a, 100b, 100c, 100d, 100e, 100f) for adjusting positions of rollers as claimed in claim 1, wherein in the grooving assembly (20), the grooving/gripping rollers (21) are movable on a grooving shaft (22), both ends (22a, 22b) of the grooving shaft (22) are connected to a first frame (24) and a second frame (25), the first frame (24) or the second frame (25) is the first reference (21a), the grooving/gripping rollers (21) are movable between the ends (22a, 22b) of the grooving shaft (22) sliding thereon and can be fixed at a position between the ends (22a and 22b) of the grooving shaft (22) by a fastener.

3. The system (100a) for adjusting positions of rollers as claimed in claim 1, wherein the input interface (30a) is a scanner adapted to scan markings of on the strip (13a).

4. The system (100b) for adjusting positions of rollers as claimed in claim 1, wherein the input interface (30b) is a keyboard, the processor (50) is embedded with a computer aided user interface application for receiving details of folds to be made on the strip (13) which is to be made by the machinery (100) and the geometric details of the grooving/gripping rollers (21).

5. The system (100c) for adjusting positions of rollers as claimed in claim 1, wherein the input interface (30) is a camera, the camera is adapted to capture the positions of grooving/gripping rollers (21″) positioned on a grooving shaft (21″) of a standard grooving assembly (20a), wherein in the standard grooving assembly (20a), grooving/gripping rollers (21″) are movable on the grooving shaft (22″), both ends (22a″ and 22b″) of the grooving shaft (22″) are connected to a first frame (24″) and a second frame (25″), the first frame (24″) or the second frame (24″) is a first reference (21a″), the grooving/gripping rollers (21″) are movable between the ends (22a″ and 22b″) of the grooving shaft (22″) sliding thereon and can be fixed at a position between the ends (22a″ and 22b″) of the grooving shaft (21″) by a fastener.

6. The system (100e) for adjusting positions of rollers as claimed in claim 1, wherein the first position adjusting mechanism (70) includes a first prime mover (70a) connected to the workstation (40);
one or more second prime movers (70b) connected to the first prime mover (70a); and
one or more first moving jaws (70c) connected to the second prime movers (70b);
wherein the workstation (40) actuates the first prime mover (70a) to move the second prime movers (70b) linearly along the grooving shaft (22) and further actuates the second prime movers (70c) to actuate the first moving jaws (70a) to grip the grooving/gripping rollers and place the grooving/gripping rollers (21) on definite positions according to the derived positions of the grooving/gripping rollers (21) from the first reference (21a).

7. The system (100e) as claimed in claim 6, wherein the first prime mover (70a) second prime mover (70b) are hydraulic or pneumatic or electrically operated linear actuators or cam operated actuators.

8. The system (100f) for adjusting positions of rollers as claimed in claim 1, includes:
a guiding unit (101), the guiding unit (101) includes one or more visible light torches (102), the guiding unit (101) is connected to the workstation (40), the workstation (40) positions the light torches (102) with beams focusing on the derived positions of the grooving/gripping rollers (21) from the first reference (21a) determined by the workstation (40);
wherein an operator can adjust positions of the grooving/gripping rollers (21) from the references (21a) with the respective beams positioned thereon.

9. The system (100d, 100g, 100h) for adjusting positions of rollers (gripping rollers/grooving rollers) in an outsert making machinery as claimed in claim 1, wherein the grooving/gripping rollers (51) are mounted on a grooving shaft (52), ends (52a and 52b) of the grooving shaft (52) are detachably connected to a first side frame (53) and a second side frame (54), the first side frame (53) and the second side frame (54) are connected to the strip making unit (10), the grooving shaft (52) receives the strip (13) and performs grooving operation thereon, wherein the positions of the grooving/gripping rollers (51) are adjusted by a grooving roller adjusting apparatus (55), the apparatus (55) includes:
a first apparatus side frame (55a); the first apparatus side frame (55a) is having a first fastening mechanism (55b)
a second apparatus side frame (55c) with a distance from the first apparatus side frame (55a), wherein the first apparatus side frame (55a) is having a second fastening mechanism (55d);
a scale (56) having marking of distances thereon;
wherein for adjusting positions of the grooving/gripping rollers (51) on the grooving shaft (52), the grooving shaft (52) with grooving rollers (51) is detached from the first side frame (24) and the second side frame (25), and the ends (52a and 52b) of the grooving shaft (52) with grooving rollers (51) are connected to the first apparatus side frame (55a) and the second apparatus side frame (55b) though the first fastening mechanism (55b) and the second fastening mechanism (55d), the first fastening mechanism (55b) and the second fastening mechanism (55d) enables rotational movements of the grooving shaft (52) around the axis of the grooving shaft (52); the grooving rollers (51) detached from the grooving shaft (52) and moved along the axis of the grooving shaft (52) and the distances of the grooving rollers (51) are adjusted from either from the first side frame (53) or from the second side frame (54) manually or by the first position adjusting mechanism (70) of the system (100d) and the grooving rollers (51) are fixed to the grooving shaft (52) at the adjusted positions, the grooving shaft (52) with the fixed grooving rollers (51) are detached from the first apparatus side frame (55a) and the second apparatus side frame (55b), and fixed to the first frame (24) and the second frame (25).

10. The system (100d) for adjusting positions of rollers (gripping rollers/grooving rollers) in an outsert making machinery as claimed in claim 9, wherein the system (100d) includes:
a guiding unit (61), the guiding unit (61) is arranged with the grooving roller adjusting apparatus (55), the guiding unit (61) includes one or more visible light torches (62), the guiding unit (61) is connected to the workstation (40), the workstation (40) positions the light torches (62) with beams focused on positions according to the derived positions of the grooving/gripping rollers (51) from the first reference (21a),
wherein an operator can adjust positions of the grooving/gripping rollers (51) from the first apparatus side frame (55a) and the second apparatus side frame (55b) with the respective beams positioned thereon.

11. The system (100g) for adjusting positions of rollers (gripping rollers/grooving rollers) in an outsert making machinery as claimed in claim 9, wherein the grooving roller adjusting apparatus (55) includes:
an inlet (81) for receiving a strip (13a) without grooves (24) thereon therethrough,
wherein upon rotation of the grooving shaft (52) with the fixed grooving rollers (51), the grooving rollers (51) perform grooving operation on the strip (13a) and a strip (13b) with the grooves (24) thereon moves away from the grooving roller adjusting apparatus (55) through an outlet (82) of the apparatus (55).

12. The system (100h) for adjusting positions of rollers (gripping rollers/grooving rollers) in an outsert making machinery as claimed in claim 9, wherein one or more grooving shafts (52) are fixed to the first apparatus side frame (55a) and the second apparatus side frame (52), the axial distances between two grooving shafts (52 and 404) are adjusted by an axial distance adjusting mechanism (90).

13. The system (100i) for adjusting positions of rollers (gripping rollers/grooving rollers) in an outsert making machinery as claimed in claim 1, the system (100i) includes a colour indication (71) on the grooving rollers (21), wherein male projections or female recessions of a set of grooving rollers (21) are provided with a same colour indication (71), wherein the display (50) displays derived positions of the rollers (21) with colour indication (71).

14. The system (100d, 100g, 100h) for adjusting positions of rollers (gripping rollers/grooving rollers) in an outsert making machinery as claimed in claim 9, the distance between the first apparatus side frame (55a) and the second apparatus side frame (55b) is equal to the distance between the first side frame (53) and the second side frame (54).
